(19) United States
(12) Patent Application Publication
(10) Pub. No.: US 2006/0271854 A1
(43) Pub. Date: Nov. 30, 2006

(54) Computer application with integrated information management

(75) Inventor: Dean Anthony Racovolis, Redmond, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/139,219

(22) Filed: May 27, 2005

(51) Int. Cl. G04F 10/00

(52) U.S. Cl. 715/704; 702/178

(57) ABSTRACT

A productivity tool for use in connection with a workgroup server. The tool may be integrated into a computer application, such as a word processor or spread sheet. With the tool, a user may create and organize links to sites, pages or artifacts on the workgroup server. The tool may incorporate browsing functionality to allow appropriate targets of the links to be identified on the workgroup server so that links may be added without the need for a user to specifically input the target address for the link. The tool allows a user to select artifacts that are the targets of the links for processing, whether by the application in which the tool run, other applications on the local computer on which that application runs or applications on the workgroup server.

### BACKGROUND OF INVENTION

1. Field of Invention

This invention relates generally to computer applications and more specifically to features within a computer application to aid in the management of documents and other information.

2. Discussion of Related Art

Computers are widely used to help individuals be more productive in their work. Computer applications, including data processing applications, provide users with a wide array of productivity tools, many of which are word processors, spread sheets and calendar programs data processing applications. Examples of data processing applications are word processors, spread sheets and calendar programs, such as applications within the MICROSOFT® OFFICE® suite of applications, including the WORD® application, which processes data that represents text documents, the EXCEL® application, which processes data that represents spread sheets, and the OUTLOOK® application, which processes data that represents e-mail messages, appointments, tasks and the like. Often, computer applications store data in files on a local computer that runs the application or in a storage device connected to the local computer over a local area network or other network. The application accesses the file to read or write data.

Productivity is increased by making it easier for many individuals to work together. Computer applications have advanced to facilitate group interactions in many different ways. One way that group interaction is facilitated is through the use of file systems that allows multiple users to access files or groups of files. Individual users running computer applications on local computers connected to a network can share information through such a file system.

Productivity has also been increased through use of the Internet to facilitate group interaction. FIG. 1 illustrates a simple computer system architecture using the Internet or other network. Local computers 110A and 110B are connected through the Internet 120 to server 130. Server 130 has a database 140 connected to it. The server recognizes an addresses on the Internet, defining a web site that can be accessed by individuals at local computers 110A and 110B that are also connected to the Internet. The local computers conventionally access web sites through a computer application known as a web browser, such as the MICROSOFT® INTERNET EXPLORER web browser.

A traditional web browser provides a user interface to display information from the server. The web browser also provides an interface through which a user may specify which information is provided by the server. Often information is transmitted over the Internet packaged as an XML page. The XML page communicates to the web browser how to display the information on the display screen of the local computer.

However, XML pages are not the exclusive format in which information is provided over the Internet. Servers may provide copies of files, which web browsers may request and download to the local computer or a storage device attached to the local computer. The web browser may also be used to perform the reverse operation of providing information to the server so that information and files may be uploaded to the server.

Though Internet websites can be used to enhance productivity, they are not designed specifically for that purpose. More recently, workgroup servers have been developed to provide features that are specifically useful for increasing productivity. For example, Microsoft, Inc. provides SHAREPOINT™ products and technologies that increase the ease with which multiple users may collaborate. The SHAREPOINT™ products and technologies implement web sites on servers accessible to many users from local computers connected over a network. That network may be the Internet, but could be any local or wide area network.

As with a traditional web site, the web sites created with SHAREPOINT™ servers may be accessed with a web browser. The sites allow for exchanges of information formatted as XML pages and also allow for files to be uploaded to the server for sharing or downloaded to a local computer for use by an individual. In addition, a SHAREPOINT™ server runs applications that perform business functions that may be used by a group working on a project, such as applications that schedule meetings or events or track tasks that are to be performed by members of a workgroup.

FIG. 2A provides an example of a user interface 200 provided by a web browser on a local computer accessing a site provided by a SHAREPOINT™ server. User interface 200 includes a display area 210 and a control area 214. Control area 214 contains controls that may be used to select a page on a server to access and to perform functions that are not specific to a particular site, such as printing or filing information.

An address field 212 displays the address of the site being accessed. A user may specify a site to access by typing the address of the site in address field 212. Alternatively, the address of the site being accessed, and therefore the address displayed in address field 212, may be provided by the web browser in response to the user activating either controls in the control area 214 or links in the display area 210.

For example, control area 214 includes a favorites control 216. When the user activates favorites control 216, the browser creates a favorites display area (not shown) that lists web pages that have been identified by a user as a “favorite.” By selecting a favorite, from that list, the web browser accesses that web page.

The favorites display area includes other controls, such as those that allow the user to add a web page to the list of “favorites,” attach a textual descriptor to a “favorite,” delete a “favorite” from the list or organize the “favorites,” such as by forming folders in which “favorites” may be grouped.

Display area 210 contains information specified by the web page being accessed. In FIG. 2A, multiple sub-areas are provided. Sub-area 228 acts as a navigation pane. It displays multiple controls, such as controls 220A and 220B. Activating a control in sub-area 228 causes a related sub-area to appear elsewhere in display area 210. In the example pictured in FIG. 2A, control 220A has been activated to cause sub-area 230A to appear. Control 220B has been activated to cause sub-area 220B to appear.

Sub-areas 230A and 230B each displays artifacts that are available for the user to access. Sub-area 230A displays artifacts that are interpreted as status reports. Artifact 232A is a file created by a computer application, such as a word processor, that is stored on a database attached to the server providing the web page accessed. Folder 234A represents a grouping of artifacts created on the server. Selecting a folder brings up a new sub-area that lists further folders or artifacts within that folder.

Display sub-area 230B contains artifacts that represent tasks to be performed as part of a project. Artifacts, such as artifact 232B, may be stored as files on the server, but may also be stored as records in a database or in other ways dictated by the server.

Depending on the type of artifact, the server providing the web site may allow the user to perform various operations on it. For example, the server may allow a user to specify updated information about an artifact storing a task or to generate an e-mail to the owner of the task in response to user input or otherwise perform operations that are appropriate for a task. The server may also allow operations appropriate for artifacts that are stored as files. For example a file may be downloaded to a local computer where it is operated on by a computer application run by a user. The modified file may then be uploaded to the server where other users can access the file.

Navigation controls within user interface 200 may be used to navigate to different pages hosted by the SHAREPOINT™ server so that a user may find different artifacts. FIG. 2B shows user interface 200 when the user has navigated to a page that presents a document library. Address field 212 contains address 252 of the document library. Display area 210 shows a list of artifacts, such as files and folders, in the document library.

The artifacts in the document library can be accessed, such as by downloading to a local computer where the documents can be operated on with computer applications. Some computer applications in the MICROSOFT® OFFICE® suite of products that run on a local computer recognize that a file has been downloaded from a SHAREPOINT™ server. When the application processes such a document, it presents a control to the user that, when activated, downloads the most recent copy of the file from the server to refresh the copy stored on the local computer. Similarly, some such computer applications include task panels with controls that allow a user to specify that a modified file is to be written back to the server.

### SUMMARY OF INVENTION

Greater workgroup productivity is enabled by integrating a link management tool directly with an application used with a workgroup server. Organization of links facilitates finding information and files and other artifacts may be operated on without expressly downloading the artifact through a separate web browser.

In one aspect, the invention relates to a computer system having a graphical user interface including a display and a user input device associated with a computer running a data processing application and a plurality of objects associated with a server connected to the computer. The computer system is operated according to a method comprising the steps of: providing a selection control in a user interface area associated with the data processing application; and in response to user input activating the selection control, providing a user interface area having a first display area adapted to display a plurality of links, each of the plurality of links linking to an associated object on the server, and a plurality of controls for configuring the directory of links.

In another aspect, the invention relates to a computer-readable medium having computer-executable instructions adapted for execution on a computer in a computer system having a server. The computer-executable instructions performing steps that comprise maintaining a directory of links to objects on the server; displaying a first user interface area associated with a data processing application, the first user interface area comprising a graphical representation of the directory of links; displaying a second user interface area, the second user interface area comprising a graphical representation of an object on the server; and adding a link in the directory of links to the object in response to user input.

In another aspect, the invention relates to a method of interacting with a workgroup server from a data processing application on a local computer, comprising the acts of creating a link directory; accessing the link directory from within the data processing application; accessing a copy of an artifact on the workgroup server in response to selection of a link from the link directory; and determining whether the artifact has a type compatible with the data processing application.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch illustrating a prior art network architecture;

FIGS. 2A and 2B are sketches of user interfaces for a web browser accessing a prior art workgroup server;

FIGS. 3A . . . 3E are sketches of a user interface for a computer application in successive operating states of a process of creating a link to an artifact on a workgroup server;

FIGS. 4A . . . 4C are sketches of a user interface for a computer application in successive operating states of a process of creating a link to an artifact on a workgroup server;

FIG. 5 is a sketch of a user interface for a computer application providing a directory of links for accessing information on a workgroup server; and

FIG. 6 is a flow chart of a process of opening an artifact from within a computer application according to an embodiment of the invention.

### DETAILED DESCRIPTION

User productivity in enterprises using workgroup servers is increased by simplifying actions of a user to locate and access files and other artifacts stored on the workgroup server. A server link management tool to facilitate access to artifacts may be integrated into computer applications intended to operate on artifacts downloaded from the workgroup server. With the server link management tool, a user may browse the workgroup server to identify artifacts. Those artifacts may be accessed directly and operated on by the computer application. If a selected artifact is not of a type to be processed by the computer application, an appropriate application is identified and the file is launched from within that application.

The server link management tool also may maintain a directory of links to objects, such as pages or artifacts, on the workgroup server to allow a user to quickly find and access desired information. The links may be managed and organized to support specific process flows or to otherwise facilitate tasks a user must perform.

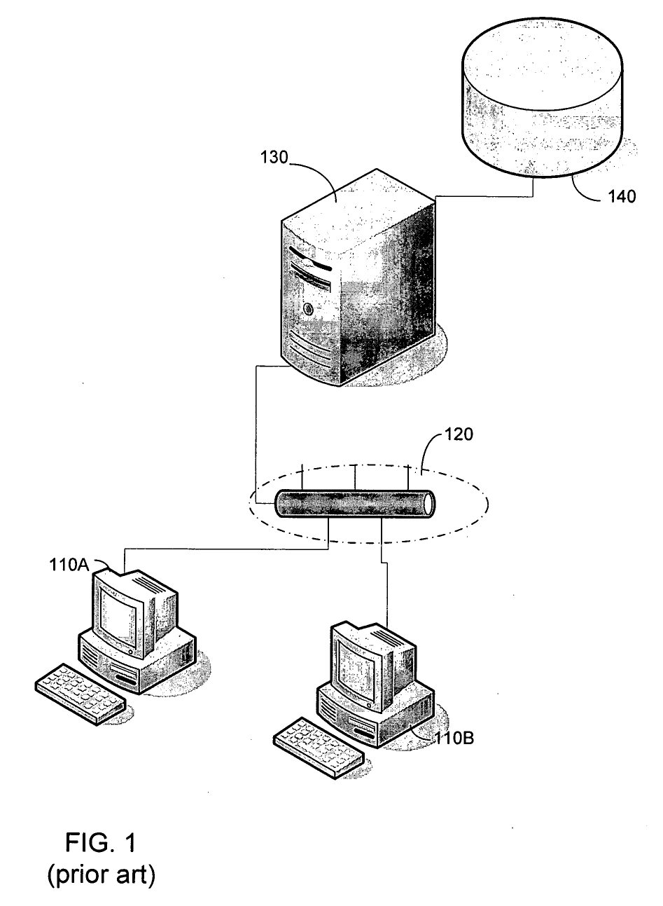

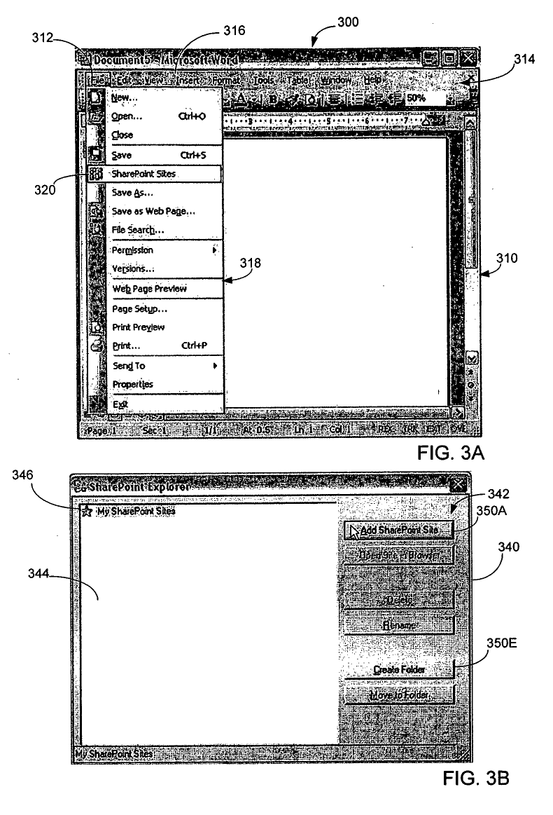

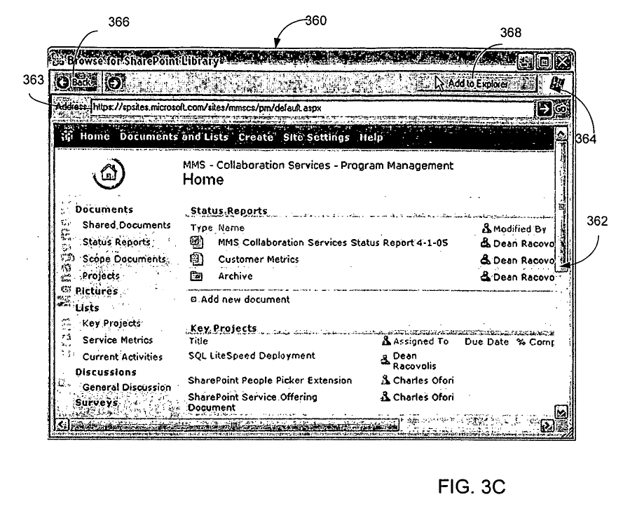

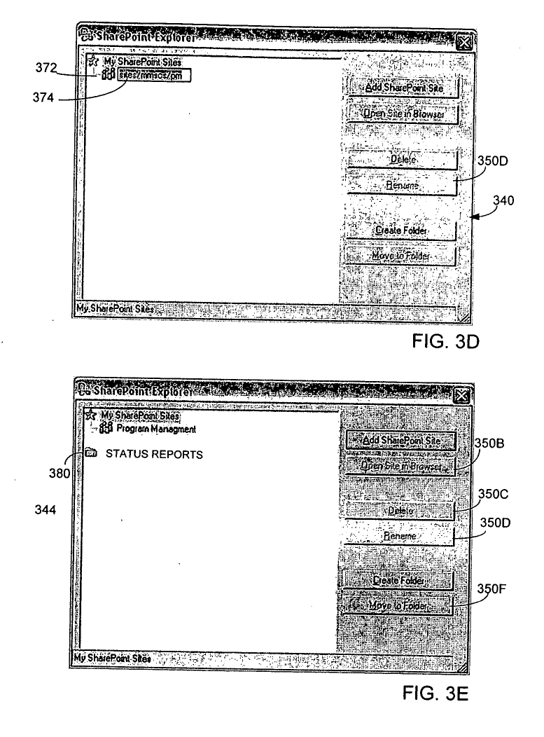

FIG. 3 illustrates a graphical user interface 300 for a computer application that may run on a local computer, such as local computer 110A or 110B (FIG. 1). The computer application may be any desired computer application, such as a word processor, spread sheet program or a mail program. In the illustrated embodiment, the application is a word processor, specifically the MICROSOFT WORD word processor.

User interface 300 may be displayed on the display of a local computer such as 110A or 11B (FIG. 1), though it may be displayed in any suitable way. The local computer also includes a user input device, which may be any user input device as is known in the art. For example, the local computer may have a keyboard, a touchpad, a mouse or other pointing device.

In the example provided herein, user input is received from a user operating a local computer that has a keyboard and a mouse. To provide inputs with the mouse, the user manipulates the mouse to indicate a position on the display. User interface software executing on the computer tracks the manipulations of the mouse and positions a cursor or other visual indicator on the display at a location controlled by manipulation of the mouse. The user interface software likewise tracks objects presented in an active area of the display by software running on the computer. When the user manipulates a button on the mouse or the keyboard or otherwise signals a selection, the user interface software associates that signal an object positioned on the display screen at the location occupied by the cursor and provides input to the software that present the associated object.

The user interface software can display various types of objects and can initiate an appropriate action in response to the user selecting a specific object. The manner in which the user signifies a selection may also impact the action initiated. For example, a control is an object that has executable code associated with it. The user may signify selection of a control by pressing a mouse button once when the cursor is positioned on the control. When the control is selected in response to the user pressing a mouse button, the user interface software may invoke the software associated with the control, thereby implementing the control function.

In contrast, when the object positioned under the cursor when the user makes a single press of a mouse button represents a file or other artifact, the user interface software may interpret this sequence of actions as user input indicating that subsequent commands are to be applied to that artifact. This sequence of actions is sometimes referred to as “selecting” the artifact.

Alternatively, if the user presses a mouse button twice in succession when the object under the cursor is a file or artifact, the user interface software may interpret this sequence of actions as user input to launch an application program that can process the artifact and transfer the focus to that application. This action is sometimes referred to as “double clicking.”

As another example, pressing and holding a button on the mouse while moving the mouse may be interpreted as user input directing that the position on the screen of the object be changed. This action is sometimes referred to as “drag and drop.”

The above described actions, such as selecting, double clicking and dragging and dropping are known in the art. A computer application according to one embodiment of the invention may operate on a platform, including a computer and related operating system, that incorporates user interface software as known in the art to receive user input in this form. However, other user interface software or other user interface mechanisms may be used.

In the illustrated embodiment, user interface 300 has a document display area 310 and a control area 314. In operation, document display area 310 presents to the user the contents of one or more documents being processed by the data processing application.

Control area 314 contains multiple controls with which a user may provide input about processing of a document appearing in display area 310. Control area 314 may contain controls as known in the art for word processors or other computer applications.

Some of the controls in control area 314 are accessible through menu bar 316. In this embodiment, menu bar 316 lists multiple menu choices. When a menu choice is selected, a drop down list of further menu choices is presented to the user. Each menu choice may, when selected, present further menu choices or initiate an action.

In the example pictured in FIG. 3A, FILE menu choice 312 has been selected. In response, user interface software has presented drop down list 318 with a list of further menu choices. Menu choices on drop down list 318 may be as are conventionally used in a word processor or other computer application as known in the art. Selecting one of the menu choices on drop down list 318 may, for example, invoke software that opens a dialog box or other user interface through which a user may specify a document to open and present in document display area 310.

List entry 320 represents a menu choice through which a tool to access files on a workgroup server may be invoked. List entry 320 may be selected by user input in any suitable way, such as by clicking on the list entry.

FIG. 3B illustrates a user interface 340 that is presented in response to the list entry 320 being selected. User interface 340 may be presented at any suitable place on a computer display that a user of the computer application can observe and may, for example, be overlaid on user interface 300.

User interface 340 includes a link display area 344. Link display area 344 may be configured to display a list of links to one or more workgroup servers. The links may point to an object on the server, such as a page within a web site or a folder, file or other artifact. Further, the links can be named or organized hierarchically to facilitate easy access for a user.

In the example of FIG. 3B, directory 346 contains no links. This example pictures a computer application that has not been customized by a user. Controls within control area 342 may be used to customize the application. FIGS. 3C, 3D and 3E illustrate a process by which a user may customize the link directory.

From the user interface 340, a user may select control 350A, providing input that the user would like to add a link to an object on the workgroup server. When control 350A is selected, user interface 360 (FIG. 3C) for the server link management tool is presented.

User interface 360 contains a display area 362, which may be the same as display area 210 in a prior art web browser. However, display area 362 may be implemented in any suitable way. Display area 362 presents information provided by the workgroup server, including links to other pages, folders, files or other artifacts available through the server.

User interface 360 contains an address field 363, which may be implemented in the same way as an address field 212 in a prior art web browser. When a user enters an address in address field 363, the server link management tool issues requests for: information to the workgroup server specified by that address. The request may be sent and information returned using an XML protocol, as in a prior art web browser/server interaction.

Each time user interface 360 is accessed, it may open the page at the address in address field 363 the last time user interface 360 was accessed. When the link management tool is first used, there will be no prior address to access and a default address may be loaded into address field 363. However, any suitable method for specifying the initial address in address filed 363 may be used. For example, an initial, or “home” address corresponding to a central page in a web site for a particular project may be specified upon installation of the link management tool and always used as the initial address whenever user interface 360 is accessed.

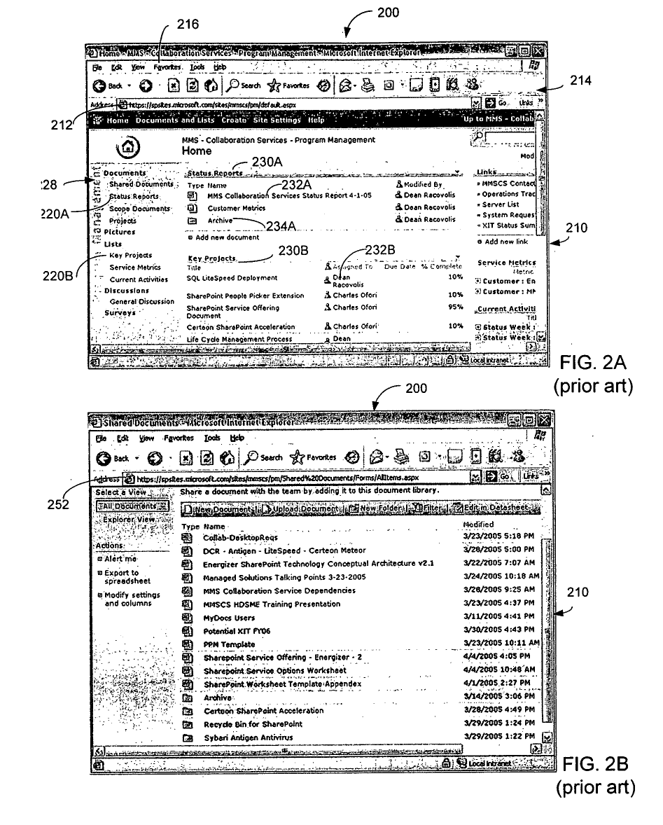

In the example of FIG. 3C, address field 363 contains the same address as address field 212 shown in the example of FIG. 2A. Accordingly, the information in display area 362 is the same as the information displayed in display area 210 (FIG. 2A). However, the user interface in FIG. 3C is invoked by a user activating controls within a word processor, which can directly process any file or other artifact downloaded from the workgroup server. In contrast, the user interface of FIG. 2A is invoked from a web browser, which downloads a file from the workgroup server after which it may be processed by a separate computer application.

Navigation through the pages of the web site may be controlled by a user selecting links displayed in display area 362. Additionally, control area 364 contains controls that may be used for navigation. Control area 364 contains navigation controls 366 that may be used to set the address in address field 362 to a prior address or to reverse that effect. In the illustrated embodiment, control area 364 contains fewer controls than a prior art web browser. However, the number and types of controls is not a limitation on the invention and a different number or a different type of control may be present in control area 364.

Control area 364 may also contain controls for creating and managing links to be used by the link management tool. In the illustrated embodiment, control 368, when activated by a user, causes a link to be added to the link directory managed by the link management tool. The link may be to an artifact selected at the time control 368 is activated. Or, if no artifact is selected, the link may be to the address displayed in address field 362. However, the specific process used to identify a link to be added to the link directory is not critical to the invention and any suitable process may be used.

FIG. 3D shows user interface 340 after a link has been added. The link is graphically displayed as an icon 372 and a name 374. In the illustrated embodiment, the name 374 defaults to the address of target of the link. In the example illustrated in FIG. 3D, name 374 is highlighted in a box, indicating that the name has been selected and may be edited by a user providing input, such as by typing a new name from a keyboard. Name 374 may be made editable by a user selecting the link in the directory and, while the link is selected, activating control 350D. However, any suitable way for invoking a program that allows the name of an entry in the link directory to be edited may be used.

In the illustrated embodiment, the visual appearance of icon 372 is used to identify the type of target to which the link points. In this example, icon 372 indicates that the link is to a web site. Other icons may be used to represent files, with specific types of files being indicated by the appearance of the icon.

FIG. 3E shows user interface 340 after name 374 has been edited. In this example, the name of the link has been changed from https://spsites.microsft.com/sites/mmscs/pm to “Program Management.” Being able to attach a meaningful name to a link allows a user to rapidly locate a specific link in the link directory, which in turn allows a user to more rapidly obtain required information.

FIG. 3E illustrates other controls that may be used to manage links in the link directory. For example, control 350C may be used to delete a selected link from the directory. Controls 350E and 350F may be used to organize links in the directory. Control 350E may be used to create folders within link directory area. When activated, control 350E creates a folder icon, such as folder icon 380, in link display area 344. A folder icon provides a way to organize links in the link directory.

A link may be filed in a folder by using control 350F while that link is selected. When activated, control 350F may open a dialog box or otherwise ask the user to identify a folder in which the link should be filed. When a link is filed in a folder, the link is visible when the folder is “open” but not displayed when the folder is “closed.” A folder icon is a control that switches between its open and closed states, and adjusts the display appropriately, when activated.

Other controls provide a method to access information on the workgroup server. When a link in the link directory is selected and control 350B is activated, the target of the link is opened in a web browser, allowing navigation through the pages hosted by the workgroup server in much the same way that pages could be navigated with a web browser. The web browser may be as in the prior art. However, in the illustrated embodiment, web browser functionality is provided by the link management tool.

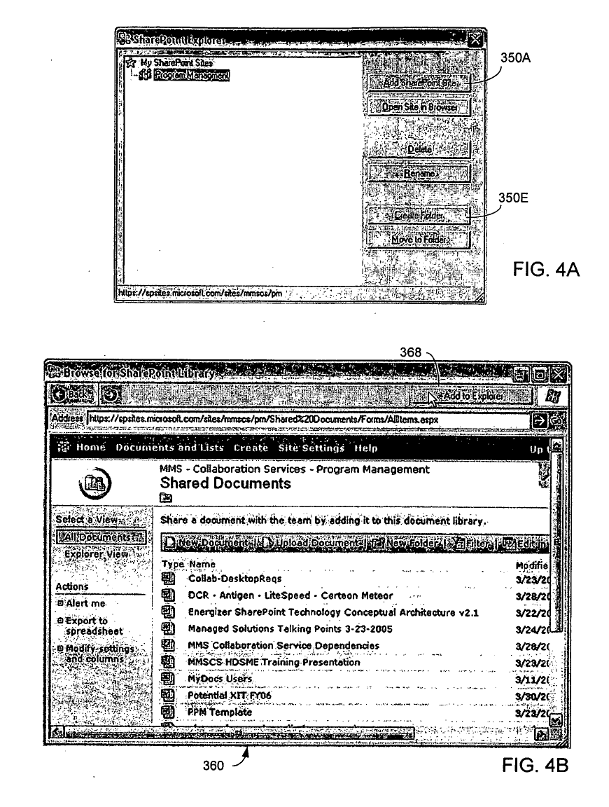

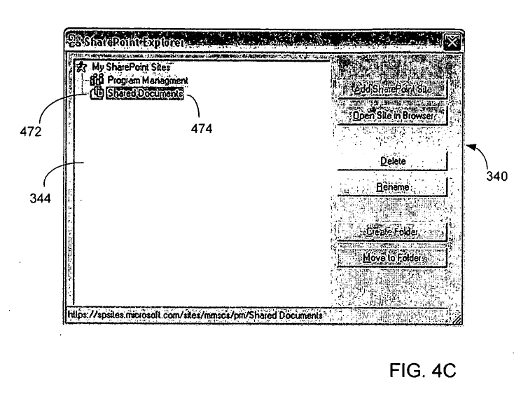

In the example of FIG. 4A, the link to the site named “Program Management” is selected. If control 350B is activated while that link is selected, a user.interface such as user interface 360 is displayed with content from the Program Management site displayed in the display area 362 (FIG. 3C).

The navigation controls associated with the user interface may then be used to find desired pages or artifacts. FIG. 4B shows user interface 360 after navigation controls, including links within display area 362, are used to display a document library. In this example, the document library is a collection of files related to a topic that have been organized on the workgroup server so that a user interested in that topic may easily find desired documents. With this document library displayed, a user may activate control 368 to add a link to that document library or a link to a document in the library to the link directory.

FIG. 4C shows user interface 340 after control 368 has been activated. Icon 472 and name 474, representing a link to the document library shown in FIG. 4B appear in link display area 344. Icon 472 has an appearance that indicates that the link points to a document library. As described above, name 474 may be assigned using control 350D.

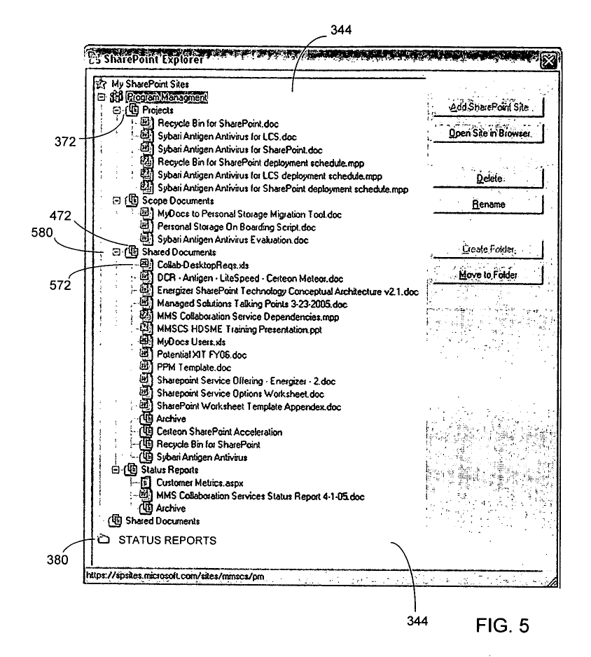

Multiple links may be added in this fashion until the user has created links to all desired pages and artifacts have been created. FIG. 5 shows link directory area 344 containing multiple links, each represented with an icon and a name so that a user may readily identify a link to desired information. For example, icon 372 identifies a site; icon 472 identifies a document library; and icon 572 identifies a file.

FIG. 5 also illustrates one method by which links may be automatically arranged hierarchically. The Program Management site represented by icon 372 is at the top level of the hierarchy. The Shared Document Library represented by icon 472 is accessed from a link contained within the Program Management site. It is therefore at a lower level of the hierarchy than the Program Management site. This hierarchy is represented by indenting icon 472 representing the Shared Document Library relative to icon 372 representing the Program Management site. Similarly, documents within the Shared Document Library are at a lower level in the hierarchy than the Shared Document Library. Icon 572 is therefore shown indented relative to icon 472.

In the described embodiment, the links are automatically arranged in an hierarchical fashion. The link management tool may, for example, identify levels of hierarchy based on the address associated with each link. Each object has an address that includes a root that is the same as the address of objects at higher levels of the hierarchy.

A further feature of the hierarchical organization is that levels of the hierarchy may be “collapsed” to hide the objects at lower levels in the hierarchy. In the pictured embodiment, each link that has items below it in the hierarchy includes a control that may be activated to toggle between displaying objects at lower levels of the hierarchy and hiding those objects. For example, with the user interface displayed in the state pictured in FIG. 5, control 580 may be activated to hide all of the documents within the Shared Documents Library. When those documents are hidden, control 580 may be activated to reveal those documents.

FIG. 5 shows a folder 380. Folder 380, and other folders created in the link display area 344 may contain multiple links. The links in each folder can likewise be arranged in a hierarchy. Further, some embodiments may allow folders to be created at any level in the hierarchy. For example, a folder could be created to hold documents within the Shared Document Library, in which case it would appear in link directory area 344 positioned in the list of objects within the Shared Document Library.

The described link management tool may be implemented in any suitable way. In the described embodiment, it is implemented using software programming techniques customarily used for developing computer applications, whether now known or hereafter developed. As one example of a possible implementation, the link management tool may be readily integrated in a word processor constructed with DLL components if it is also implemented with DLL components.

The link management tool may be readily integrated in a drop down list in a computer application that is designed to be extensible, such as the MICROSOFT WORD word processor. Such an extensible program is designed to be customized to include list entries in drop down lists that invoke added tools or other programs. However, access to the link management tool may be provided in any way, now known or hereafter developed, that access is provided to other tools from within a computer application.

Likewise, the features of the link management tool, such as dynamically adding entries to lists, deleting entries from a list, expanding or contract lists, can be implemented by one of skill in the art using known programming techniques.

The link management tool stores information defining the links in a computer-readable medium associated with the local computer on which the tool runs. Likewise, information defining the hierarchy of links and folders or other structures used to organize the links may also be stored in the computer-readable medium. In operation, the link management tool does not directly alter the information stored at the target of the links. Rather, adding, deleting or renaming links in the link management tool alters the information stored in the data structure associated with the link management tool.

A link management tool provides productivity advantages when integrated into a computer application such as a word processor. Such a tool allows a user to quickly access information on a workgroup server. It can enable a user to quickly find information needed to perform specific tasks without browsing the contents of a site on the workgroup server. By allowing links to multiple files or artifacts related to a specific task to be stored in a folder, the link management tool enables files to be organized in way that speeds performance of the task. By integrating the tool with a data processing application, the tool can open selected files or artifacts in that data processing application or can launch another application appropriate for processing the file or artifact selected, which can speed processing or provide an improved user experience.

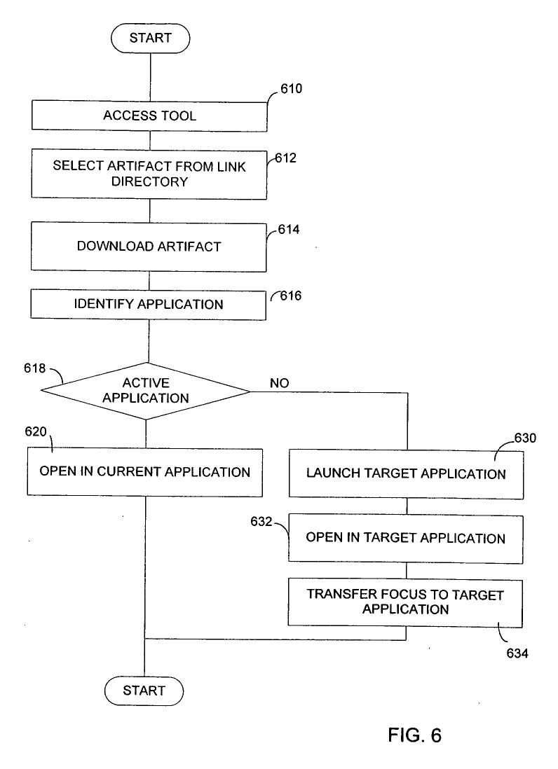

FIG. 6 is flow chart of a process by which an artifact is opened directly from a link management tool. At process block 610, the link management tool is accessed. The tool may be accessed by activating a control, through a keystroke command or in any other suitable way. In this embodiment, the link management tool is accessed by selecting a list entry from a dropdown list, as shown in FIG. 3A. Accessing the tool may make available a user interface with a link directory, such as is illustrated in FIG. 5.

At process block 612, an artifact is selected from the link directory. The link directory may contain entries that have been expressly saved in the link management tool by a user or system administrator or may be populated in any other suitable way. Any suitable method for selecting an entry may be used. In this example, the artifact is a file that is selected by double clicking on either the icon or name displayed in connection with a link to that file.

At process block 614, the selected file is accessed. In the described embodiment, a file or other artifact that is to be processed by a user running a computer application from a local computer is downloaded from the workgroup server. The tool formats and sends the request for a copy of the file in a format that is prescribed by the program interface, often called an API, used by the workgroup server. The copy of the file may be stored on the local memory associated with the computer running the computer application or in any other suitable location.

At step 616, the link management tool identifies a computer application that can operate on the downloaded artifact. Many applications store files with some indicia of the application for which the file is formatted such that the application can be identified by reading that indicia. The indicia may be a file extension, a code embedded in a file header or any other suitable indicia of file type.

At decision block 618, the link management tool makes a determination whether the file can be processed by the application in which the link management tool is operating. If so, the process proceeds to the process block 620. At process block 620, the file is opened within that application. The file may be opened using software routines of the type that are conventionally used to open files within an application.

Conversely, if, at decision block 618 it is determined that the file was developed for processing by a different application, processing proceeds to processing block 630. At processing block 630, the application identified at step 616 is launched as the target application. Software that launches an application, whether now known or hereafter developed, may be used to perform the processing of processing block 630.

At processing block 632, the downloaded file is opened in the target application. The processing may be similar to the processing performed at processing block 620, with the exception that the processing results in the file being opened in the target application rather than the application from which the link management tool was invoked.

At processing block 634, the focus is transferred to the target application in which the selected file has been opened. On a platform that allows multiple applications to run simultaneously, one application is said to have the “focus.” The operating system on such a platform often signals which display area corresponds to the application with the focus because that display area is superimposed on top of any other display areas. The display area also may be made visually distinctive from the display areas corresponding to applications that do not have the focus. User inputs generally impact the application with the focus, until the focused is changed. By transferring the focus to the computer application that can operate on the selected file, the tool allows a user to immediately begin processing the selected file, without, for example, needing to download and store a copy of the file and then separately opening an application in which it can be processed.

Having thus described several aspects of at least one embodiment of this invention, it is to be appreciated that various alterations, modifications, and improvements will readily occur to those skilled in the art.

For example, it is described above that a computer application executes on a local computer. The term “local” identifies a computer that shares information with a server without regard to physical location or physical proximity to the server. The local computer could be in the same room or same building as the server. The local computer could be connected to the server in any suitable way. For example, it could be connected over a local area network, a wide area network, a corporate intranet, a virtual private network or the Internet.

As another example, the process illustrated by FIG. 6 may be augmented with a third choice at decision block 618. If the application with which the selected artifact is associated runs on the workgroup server, the link management tool may, instead of downloading a copy of the artifact and opening that copy within an application on a local computer, send commands to the workgroup server for processing to be performed on the selected artifact. The tool may, for example, launch a web browser on the local computer and provide the target of the link as the address.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, the invention may be embodied as a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiment.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. In a computer system having a graphical user interface including a display and a user input device associated with a computer running a data processing application and a plurality of objects associated with a server connected to the computer, a method comprising the steps of:
(a) providing a selection control in a user interface area associated with the data processing application; and
(b) in response to user input activating the selection control, providing a user interface area having a first display area adapted to display a plurality of links, each of the plurality of links linking to an associated object on the server, and a plurality of controls for configuring the directory of links.

2. The method of claim 1, wherein the step (a) of providing a selection control comprises providing a selection control in a dropdown list.

3. The method of claim 2, further comprising the step of:
(c) receiving a user input selecting a FILE menu and providing the dropdown list in response thereto.

4. The method of claim 1, additionally comprising the step of:
(c) in response to a user input activating one of the plurality of controls, providing a second user interface having a second display area displaying information provided by the server and a plurality of navigation controls for specifying an address on the server from which the information displayed in the second display area is obtained.

5. The method of claim 1, wherein at least one of the objects on the server is a file and the method additionally comprises the step of:
(c) in response to a user input specifying one of the plurality of links, opening the file.

6. The method of claim 1, wherein at least one of the objects on the server is a directory of documents and the method additionally comprises the step of:
(c) in response to a user input specifying one of the plurality of links, providing a second user interface having a first display area adapted to display representations of documents in the document library.

7. The method of claim 1, additionally comprising the step of:
(c) in response to a user input specifying one of the plurality of links, providing a second user interface having:
i) a first display area adapted to display a representation of an object on the server
ii) at least one navigation control that selects the object displayed in the first display area; and
iii) a control to add to the plurality of links displayed in the user interface in the step (b) a link to the object.

8. A computer-readable medium having computer-executable instructions adapted for execution on a computer in a computer system having a server, the computer-executable instructions for performing steps comprising:
(a) maintaining a directory of links to objects on the server;
(b) displaying a first user interface area associated with a data processing application, the first user interface area comprising a graphical representation of the directory of links;
(c) displaying a second user interface area, the second user interface area comprising a graphical representation of an object on the server; and
(d) adding a link in the directory of links to the object in response to user input.

9. The computer-readable medium of claim 8 installed on a local computer, the local computer including the data processing application.

10. The computer-readable medium of claim 8, wherein the object comprises a web page and the step (b) of displaying a first user interface area comprises displaying a link to the object with an associated icon of a first type.

11. The computer-readable medium of claim 10, wherein:
the computer-executable instructions are additionally for performing steps comprising:
(e) displaying a graphical representation of a second object on the server in the second user interface area in response to a user manipulating at least one navigation control associated with the second user interface area; and
the second object comprises a document library and the step (b) of displaying a first user interface area comprises displaying a link to the second object with an associated icon of a second type, visually different than the first type.

12. The computer-readable medium of claim 1 1, wherein:
the computer-executable instructions are additionally for performing steps comprising:
(f) displaying a graphical representation of a third object on the server in the second user interface area in response to a user manipulating at least one navigation control associated with the second user interface area; and
the third object comprises a document in the document library and the step (b) of displaying a first user interface area comprises displaying a link to the third object with an associated icon of a third type, visually different than the first type and the second type.

13. The computer-readable medium of claim 12, wherein the step (c) for displaying a second user interface area comprises displaying the at least one navigation control and displaying a control through which a user may provide the user input to cause the step (d) for adding a link to the directory of links.

14. A method of interacting with a workgroup server from a data processing application on a local computer, comprising the acts of:
(a) creating a link directory;
(b) accessing the link directory from within the data processing application;
(c) accessing a copy of an artifact on the workgroup server in response to selection of a link from the link directory; and
(d) determining whether the artifact has a type compatible with the data processing application.

15. The method of claim 14 additionally comprising the act of:
(e) when the artifact has a type compatible with the data processing application, opening the artifact in the data processing application.

16. The method of claim 14, additionally comprising the act of:
(e) when the artifact does not have a type compatible with the data processing application, opening the artifact in a second data processing application compatible with the type of the artifact.

17. The method of claim 14 wherein the act (a) comprises:
i) displaying a user interface area comprising a representation of an object on the workgroup server;
ii) receiving user input specifying the object for which a representation is displayed in the user interface area; and
iii) receiving user input to add a link to the object displayed in the user interface area to the link directory.

18. The method of claim 14 wherein the act (a) comprises the act of:
i) receiving user input specifying the organization of links in the link directory.

19. The method of claim 18 wherein the act i) comprises the act of:
A) receiving user input to create a folder.

20. The method of claim 19 wherein the act i) additionally comprises the act of:
B) receiving user input specifying links to be displayed within the folder.
